(19) United States
(12) Patent Application Publication
(10) Pub. No.: US 2002/0029270 A1
(43) Pub. Date: Mar. 7, 2002

(54) Network extender module

(76) Inventor: Andre Szczepanek, Hartwell (GB)

Correspondence Address: TEXAS INSTRUMENTS INCORPORATED, P O BOX 655474, M/S 3999, DALLAS, TX, 75265

(21) Appl. No.: 09/928,188

(22) Filed: Aug. 10, 2001

(30) Foreign Application Priority Data
Sep. 6, 2000 (GB) 0021873.5

(51) Int. Cl. G06F 15/16

(52) U.S. Cl. 709/225; 709/227

(57) ABSTRACT

An improved network extender module 6 connects multiple data sources (1 and 2) to a network 3. This invention facilitates the addition of a Voice over Internet Protocol (VoIP) telephone 1 to be added to a system without any significant degradation in the performance of data transmission between a computer workstation 2 and a network 3.

This application claims priority under 35 USC §(e)(1) of British Application Number 0021873.5 filed Sep. 6, 2000.

The present invention relates to communications over a data network and more especially to voice telephony over a conventional Ethernet network.

Voice Over Internet Protocol (VOIP) is a protocol that facilitates the use of a data network for voice telephony. A VOIP telephone system can be incorporated into a computer workstation but most users prefer a separate handset that is more in keeping with a conventional telephone system. In order to use a separate handset, the VOIP telephone and the computer workstation can share a network connection, or else they will require separate network connections. Many computer workstations are equipped with only one network connection and so it is advantageous to provide a system in which the computer workstation and the VOIP telephone can share the same network connection. Circuit modules that enable more than one system to connect to a network using the same network connection are known as network extender modules.

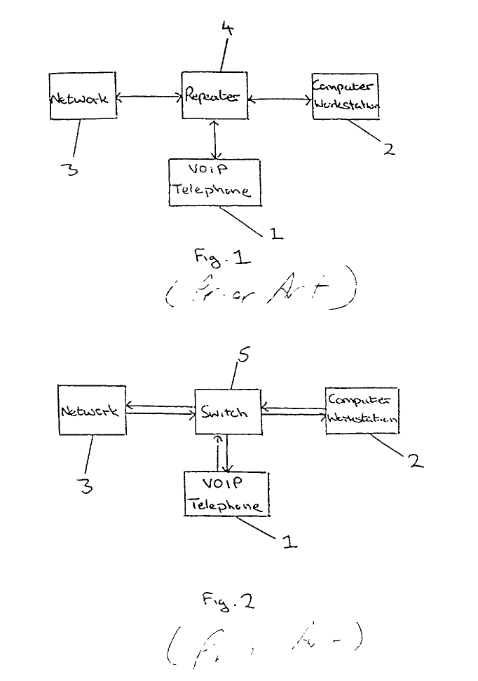

A known half-duplex VOIP system uses the configuration shown in FIG. 1. A VOIP telephone 1, computer workstation 2 and network 3 are each connected to a repeater 4. When one of the VOIP telephone 1, computer workstation 2 or network 3 wishes to transmit data, that device must acquire control of the repeater 4. Data can then be transferred from that device to the repeater 4. The repeater 4 then repeats that incoming data to the other two ports. In this way, the repeater 4 allows data to be transferred from the computer workstation 2 to the network 3, from the network to the computer workstation, from the VOIP telephone 1 to the network and from the network to the VOIP telephone. Further, the repeater 4 allows control data to pass between the computer workstation 2 and the VOIP telephone 1.

A major disadvantage with the configuration of FIG. 1 is that the connection is half-duplex (i.e. in only one direction at a time). Full-duplex connections on the other hand have twice the bandwidth of half-duplex connections. Further, for two-way traffic, there is no need for the two ports to compete for control of the network when a full-duplex connection is used; both ports can transmit at the same time.

It is an object of the present invention to provide an improved means of adding, for example, a VOIP telephone connection to a conventional computer workstation to data network connection using a single network connection.

An embodiment of the network extender module will now be described by way of example only with reference to the accompanying drawings, of which:

FIG. 1 is a block diagram of a known half-duplex VOIP telephone system;

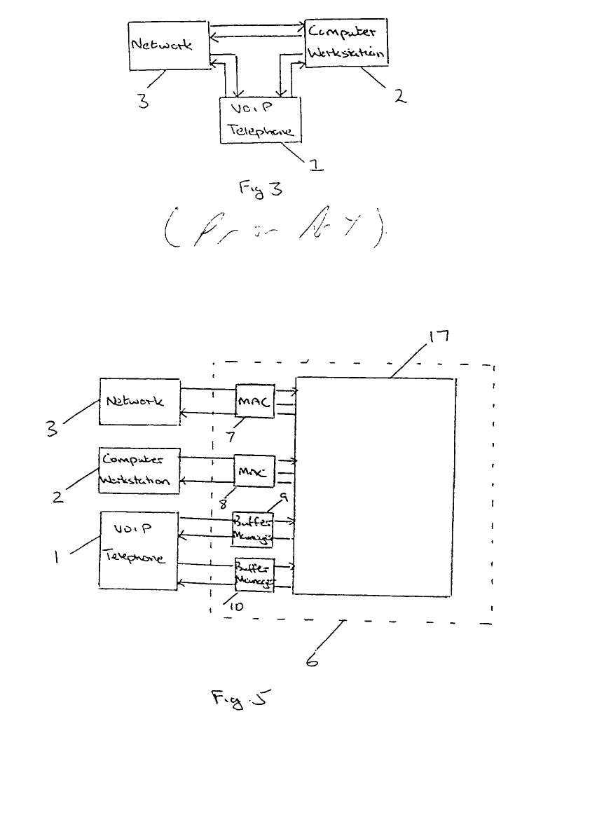

FIG. 2 is a block diagram of a full-duplex VOIP telephone system using a three-port switch;

FIG. 3 is a graphical representation of the data flow in the telephone system of FIG. 2;

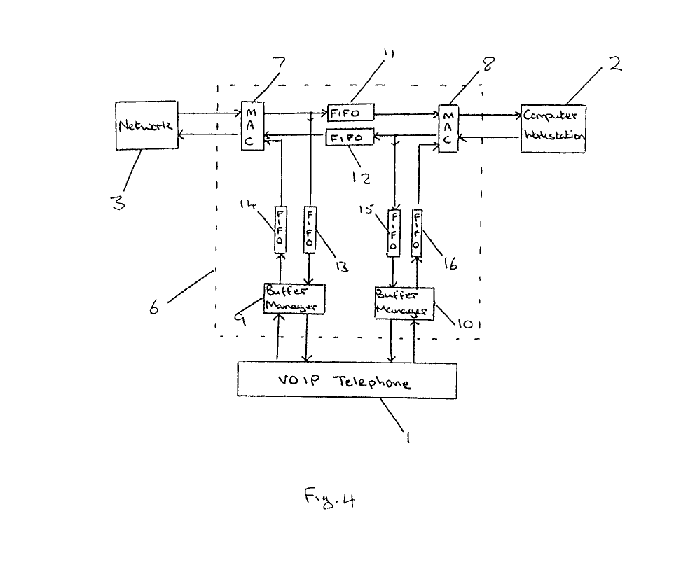

FIG. 4 is a block diagram of a full-duplex VOIP telephone system including a network extender module in accordance with the present invention;

FIG. 5 is a block diagram of the VOIP telephone system of FIG. 4 implemented using RAM.

FIG. 2 shows a configuration that provides full-duplex connections. In FIG. 2, the repeater 4 of FIG. 1 is replaced by a three-port switch 5. Each port of the switch provides two connections—a line in and a line out—in order to provide a full duplex connection. A switch allows data received at a port to be routed in general to any other one of its ports; the internal structure of the switch needed for that routing is complex and will now be described.

Two known methods of handling the transfer of broadcast packets of data in the switch 5 are (1) making a copy of each incoming broadcast packet for each destination port and (2) using data structures to manage packet data such that a single copy of each broadcast packet can be referred to by each destination port. The first method requires relatively high bandwidth since multiple copies of the same data will be created. The second method requires memory management to ensure that the single copy of the data only exists until all destination ports have sent that data. One possible implementation is to use linked lists. The linked lists form queues of packets, for example broadcast packets, for each port of the switch, with packets able to exist on more than one queue. Each packet can only be deleted once it has been un-linked for all of its destination queues. This last option is more complicated.

The data traffic in a VOIP switch module, such as that of FIG. 2, consists of three channels:

1. Computer data traffic between the network 3 and the computer workstation 2;

2. VOIP traffic between the VOIP telephone 1 and the network 3;

3. Occasional control traffic between the VOIP telephone 1 and the computer workstation 2.

The three data traffic channels are shown diagrammatically in FIG. 3.

The traffic between the network 3 and the computer workstation 2 comprises the bulk of the traffic that passes through the switch 5 with the control traffic between the VOIP telephone 1 and the computer workstation 2 being relatively infrequent. The present invention makes use of the restricted data flow, in particular by simplifying the overall buffering requirements.

An embodiment of a network extender module according to the present invention is shown in FIG. 4. In use, the network extender module 6 of FIG. 4 replaces the switch 5 of FIG. 2. The network extender module 6 comprises two media access controllers (MACs) 7 and 8, two buffer managers 9 and 10 and six first-in-first-out (FIFO) buffers 11 to 16.

MAC 7 controls the flow of data to and from the network 3, MAC 8 controls the flow of data to and from the computer workstation 2. Buffer managers 9 and 10 control data flow to and from the VOIP telephone 1 but buffer manager 9 handles the traffic between the network 3 and the VOIP telephone 1 and buffer manager 10 handles the traffic between the computer workstation 2 and the VOIP telephone. FIFOs 11 to 16 are connected between MACs 7 and 8 and buffer managers 9 and 10 in order to regulate the flow of data between them. FIFO 11 regulates the flow of data from MAC 7 to MAC 8, FIFO 12 regulates the flow of data from MAC 8 to MAC 7, FIFOs 13 and 14 regulate the flow of data from MAC 7 to buffer manager 9 and from buffer manager 9 to MAC 7 respectively and FIFOs 15 and 16 regulate the flow of data from MAC 8 to buffer manager 10 and from buffer manager 10 to MAC 8 respectively.

Each of MACs 7 and 8 perform the data serialisation and deserialisation and handle the network access protocols that are required for transferring data to and from the network 3 and to and from the computer workstation 2, using preferably standard network protocols. Buffer managers 9 and 10 transfer packets of data to and from the VOIP telephone 1 and MACs 7 and 8. Data transferred between the VOIP telephone 1 and the network extender module 6 is generally via a physically short connection and is of low bandwidth. Therefore, it is not necessary there to use data transmission techniques. The buffer managers 9 and 10 are not required to handle network access protocols or to perform data serialisation and deserialisation; the data can be passed to and from the VOIP telephone in parallel and since the VOIP telephone may be designed specially to work with the network extender module and indeed may be part of the same unit a non-standard transmission protocol may be used. The buffer managers 9 and 10 are therefore in the preferred embodiment much simpler devices than MACs 7 and 8.

MAC 7 takes data from FIFOs 12 and 14 (one at a time) and MAC 8 takes data from FIFOs 11 and 16. The data is then buffered and passed to the network (in the case of MAC 7) or the computer workstation (in the case of MAC 8). MACs 7 and 8 also receive data from the network 3 and the computer workstation 2 respectively and route that data to one or both of FIFOs 11 and 13 (in the case of MAC 7) and FIFOs 12 and 15 (in the case of MAC 8). Incoming data that is addressed to a particular source (unicast data) is routed to the appropriate FIFO. Data that is not so addressed (broadcast data) is routed to both of the relevant FIFOs. Control circuitry (not shown) responsive to relevant address portions of the incoming packets activates the MACs and FIFOs appropriately to achieve this. This circuitry is preferably connected to be responsive to the address portions when the packet is in the MAC into which it is received from the network or the computer workstation. Preferably, the address recognition takes place either prior to or during the transfer of data from the MACs to the FIFOs. If the address recognition occurs during the transfer of data, the FIFOs pointers may be manipulated in order to purge written data that is unwanted.

Buffer managers 9 and 10 take data from FIFOs 13 and 15 respectively, buffer the data and transfer it to the VOIP telephone 1. Buffer managers 9 and 10 also take data from the VOIP telephone 1, buffer the data and pass it to FIFOs 14 and 16 respectively. The VOIP telephone 1 is preferably constructed to send and receive voice and control data for the network to and from buffer manager 9 and to send and receive control data to and from the computer workstation via buffer manager 10. The connection between VOIP telephone 1 and network extender module 6 may be a single bus on which data to and from the computer workstation 2 and data to and from the network 3 would be interleaved. The interleaved data is then routed as required by a single buffer manager, that buffer manager performing the functions of buffer managers 9 and 10 by sequentially servicing both sets of FIFOs 13 and 14, and, 15 and 16. Otherwise the circuitry of VOIP telephone is conventional.

Data entering MAC 7 and intended for the network may arrive from either the VOIP telephone 1 via FIFO 14, or from the computer workstation 2 via FIFO 12. MAC 7 therefore requires a method for selecting the next data, especially when both FIFO 12 and FIFO 14 are ready to transmit a packet of data.

The simplest form of control gives either the VOIP telephone 1 or the computer workstation 2 priority. Under normal circumstances, the VOIP telephone 1 should have priority since the user will readily notice an increase in the latency of telephonic data. If the VOIP telephone 1 is given priority at all times, as is preferable, when data from FIFO 12 and FIFO 14 are ready to be sent to MAC 7 at the same time, the MAC simply transmits the data packet from FIFO 14 and signals FIFO 12 to prevent it from sending its packet. This data transfer will continue until FIFO 14 is empty; MAC 7 would then take data from FIFO 12. The same method is used by MAC 8 to handle data arriving simultaneously from FIFOs 11 and 16, preferably with the VOIP telephone 1 having priority.

It will be appreciated that other packet priority schemes could be devised and the invention is not limited to the examples disclosed herein.

Such possible schemes include round robin prioritisation, where the MACs alternate between which of two competing sets of data they transmit and bandwidth allocation, where prioritisation is based on the amount of bandwidth consumed by the transmissions. In the present case, however, giving the VOIP telephone 1 priority at all times is preferable for at least three reasons. First, it meets the low latency requirements of the VOIP telephone data. Second, it will not greatly hinder the transfer of data between the network 3 and the computer workstation 2, due to the low bandwidth of the VOIP telephone data. Third, it is a very straightforward scheme to implement.

In addition to receiving data from two FIFOs, MACs 7 and 8 can, as noted above, also transmit data to two FIFOs. Refer to FIG. 4; MAC 7 can transmit data to the computer workstation 2 via FIFO 11, to the VOIP telephone 1 via FIFO 13, or to both; MAC 8 can transmit data to the network 3 via FIFO 12, to the VOIP telephone 1 via FIFO 15, or to both.

Preferably, this flow of data is controlled by providing MAC 7 with a data bus that is connected to the input of both FIFO 11 and FIFO 13 and providing control signals on specific conductors for each of FIFOs 11 and 13 indicating whether the data on the data bus is intended for that FIFO, each of FIFOs 11 and 13 ignoring any data at its input when the control signals indicate that the data is for the other FIFO. Each of FIFOs 11 and 13 then only latches data that is intended for it. Alternatively, the FIFOs 11 and 13 may latch all data with the pointers in the FIFO being manipulated to purge unwanted data to prevent it from filling the FIFO buffers. It would be possible to allow data and control signals to be latched into FIFOs and to allow MAC 8 and buffer manager 9 to filter out the unwanted data, this is less advantageous than the other two arrangements as it risks filling the FIFOs with unwanted data. Broadcast packets received by MAC 7 are copied into both of FIFOs 11 and 13.

Any of the methods of controlling the flow of data from MAC 7 to FIFOs 11 and/or 13 discussed above can also be used for controlling the flow of data from MAC 8 to FIFOs 12 and 15. In the preferred embodiment of the invention, a single data bus is provided to pass data from MAC 7 to FIFOs 11 and 13 and from MAC 8 to FIFOs 12 and 15 with individual control signals indicating whether that data is intended for that FIFO.

The majority of the data flow will be between network 3 and computer workstation 2 and vice-versa. Consider data flowing from the computer workstation 2 to the network 3; a packet of data is transmitted to MAC 8 which routes that packet of data to FIFO 12 (and possibly also to FIFO 15). When that packet of data reaches the far end of FIFO 12, the data is passed to MAC 7. MAC 7 buffers that signal and drives the connection to the network. Similarly, a packet of data received at MAC 7 from the network 3 will be routed to FIFO 11 (and possibly also to FIFO 13). This packet of data will be passed to MAC 8 which buffers that signal and drives the connection to the computer workstation 2.

The situation described concerns the transfer of data between the computer workstation 2 and the network 3 when the VOIP telephone 1 is not in use. In those circumstances, the only delays introduced in the connection between the computer workstation 2 and the network 3 are caused by passing the data through MACs 7 and 8 and FIFOs 11 or 12. Thus the provision of VOIP telephone 1 does not significantly detract from the performance of the computer workstation when the VOIP telephone is not in use. Indeed, since the processing of data in the network extender module 6 will typically be much quicker than the transfer of data over the network 3, the delay in the transfer of data between the computer workstation 2 and the network caused by the introduction of the VOIP telephone 1 when that telephone is not in use can be made negligible. This is important because the bulk of the data transmitted will be between the computer workstation 2 and the network 3 and the user will not be aware of any significant degradation in performance as a result of the addition of the extender module and a VOIP telephone 1.

Since it is possible to receive more data for a port than it is able to transmit, flow control is provided in order to prevent packets from being lost due to the build-up of a backlog of packets of data awaiting transmission. In the preferred embodiment, the module includes means for sending a flow control packet to a data source to indicate that it should stop transmitting data to the module. This issue also has implications for the minimum size of the FIFOs 11 and 13. If the data source has started to send a packet of data to the module at the point at which flow control is deemed to be needed, the flow control packet must wait for that packet to be transferred before it can be sent. If that flow control packet arrives at the data source just after that source has started to send a packet, that packet will be sent before the data source is stalled. Thus two packets of data may need to be buffered after the point at which flow control is deemed necessary. Thus FIFOs 11 and 12 need to be relatively large. With data packets of 1.5 kilobytes (kB), FIFOs 11 and 12 should both be at least 6 kB.

An alternative embodiment of the invention, as shown in FIG. 5, also has a MAC 7 for the network 3, a MAC 8 for the computer workstation 2 and two buffer managers 9 and 10 for the VOIP telephone 1. FIFOs 11 to 16 are, however, replaced with a single RAM 17. RAM 17 may be divided into a number of memory blocks, with each block representing one of the FIFOs 11 to 16. In this way, RAM 17 is used to implement the FIFOs of FIG. 4 simply. Alternatively, the allocation of memory in the RAM 17 may be dynamic, memory representing FIFOs 11 to 16 being varied as required by the relative throughput of data. Such dynamic allocation of RAM could be implemented using a linked-list structure. For simplicity broadcast packets are copied to the lists for each (i.e. both of the two possible) destination.

The network extender module 6 shown in FIG. 4 includes one FIFO for each data route shown in FIG. 3. It may be advantageous to provide more FIFOs than this. For example, some classes of data may be more important than others. In such circumstances each of the FIFOs in FIG. 4 could be replaced with two FIFOs, one for priority data and one for less important data taking the same route. The FIFOs carrying important data would then be given priority over other FIFOs. This is particularly advantageous for the VOIP telephone 1 as it would enable the VOIP data packets carrying voice information to be given priority over other VOIP data (such as control information bound for the network, for example, the telephone at the other end of a telephone call), since it is particularly important for the voice information not to be delayed. Therefore it is advantageous (at the cost of extra circuitry) to provide two FIFOs for transferring packets from buffer manager 10 to MAC 7, the first of these for voice information and the second for other VOIP data (e.g. control data) the first being given priority over the second.

Since the network extender module of the present invention may take the form of a separate module that can be added to a preexisting computer workstation, a convenient place for the network extender module is as part of a VOIP telephone unit. It could also be provided in the computer, for example as part of a network card in the computer. If the module is provided in the computer then the other conventional circuits of the VOIP telephone could also be provided on the computer (e.g. on the network card).

The network extender module may be implemented in hardware. MACs 7 and 8 and buffer managers 9 and 10 may, for example, be provided as ASIC modules, with the FIFO buffers being provided by the ASIC or by a separate memory block as shown in FIG. 5.

1. A module for connecting first and second data sources to a network using a single network connection, comprising:
first and second interface means respectively for passing data to and from the network and to and from the first data source, the module being arranged to transmit data from the first interface means to the second interface means and from the second interface means to the first interface means so as to allow communication between the first data source and the network when they are connected to the module; and
first and second restricted interface means both for passing data to and from the second data source,
the module being arranged to transmit data from the first restricted interface means to the first interface means and from the first interface means to the first restricted interface means so as to allow communication between the second data source and the network when they are connected to the module but not to transmit data between the first restricted interface means and the second interface means, and being arranged to transmit data from the second restricted interface means to the second interface means and from the second interface means to the second restricted interface means so as to allow communication between the second data source and first data source when they are connected to the module but not to transmit data between the second restricted interface means and the first interface means.

2. A module as claimed in claim 1, wherein the first restricted interface means passes data between the second data source, when that is connected, and the first interface means only and the second restricted interface means passes data between the second data source, when that is connected, and second interface means only.

3. A module as claimed in claim 1 including means for determining whether data received into the module via the first interface means is addressed for transmission from the module via the first restricted interface means or via the second interface means and for determining whether data received into the module via the second interface means is addressed for transmission from the module via the second restricted interface means or via the first interface means, the module being arranged to route the data accordingly.

4. A module as claimed in claim 3, wherein said means for determining the intended destination of data received into the module via the first and second interface means is responsive to an address when the data is in the first and second interface means respectively.

5. A module as claimed in claim 1, wherein the first and second interface means are media access controllers.

6. A module as claimed in claim 1, wherein the first and second restricted interface means are arranged to transfer data to and from a Voice Over Internet Protocol (VOIP) telephone.

7. A module as claimed in claim 1 comprising buffering means for regulating the flow of data between the interface and restricted interface means.

8. A module as claimed in claim 7, wherein the buffering means comprises a plurality of FIFO buffers.

9. A module as claimed in claim 8, wherein the plurality of FIFO buffers comprise: a first FIFO regulating the flow of data from the first interface means to the second interface means, a second FIFO regulating the flow of data from the second interface means to the first interface means, a third FIFO regulating the flow of data from the first interface means to the first restricted interface means, a fourth FIFO regulating the flow of data from the first restricted interface means to the first interface means, a fifth FIFO regulating the flow of data from the second interface means to the second restricted interface means and a sixth FIFO regulating the flow of data from the second restricted interface means to the second interface means.

10. A module as claimed in claim 9, comprising at least one further FIFO connected in parallel with one of the said first to sixth FIFOs, the parallel FIFOs carrying data of different importance, the relevant interface or restricted interface means dealing with data from the parallel FIFOs in order of the relative importance of the data carried by the FIFOs.

11. A module as claimed in claim 10, wherein a said further FIFO is connected in parallel with the said fourth FIFO, the module being arranged to place voice data from the first restricted interface means in one of those two FIFOs and other data from the first restricted interface means in the other and to give priority in the transmission of data from those two FIFOs to the voice data.

12. A module as claimed in claim 7, wherein the FIFO buffers are implemented in a memory device with each FIFO being represented by a group of memory locations.

13. A module as claimed in claim 12, wherein the memory device is a RAM.

14. A module as claimed in claim 12 or claim 13 comprising means for dynamically allocating memory locations to the FIFO buffers.

15. A module as claimed in claim 1, further including means for prioritising the transmission via the first interface means of data that arrive into the module via the second interface means and the first restricted interface means.

16. A module as claimed in claim 15, wherein data arriving via the first restricted interface means takes priority over data arriving via the second interface means.

17. A module as claimed in claim 1, further including means for prioritising the transmission via the second interface means of data that arrive via the first interface means and the second restricted interface means.

18. A module claimed in claim 17, wherein data arriving via the second restricted interface means takes priority over data arriving via the first interface means.

19. A module as claimed in claim 1, wherein the first and second restricted interface means are provided by common circuitry arranged to handle data from the first interface means alternately with data from the second interface means.

20. A computer having a module for connecting first and second sources to a network using a single network connection, comprising:
first and second interface means respectively for passing data to and from the network and to and from the first data source, the module being arranged to transmit data from the first interface means to the second interface means and from the second interface means to the first interface means so as to allow communication between the first data source and the network when they are connected to the module; and
first and second restricted interface means both for passing data to and from the second data source, the module being arranged to transmit data from the first restricted interface means to the first interface means and from the first interface means to the first restricted interface means so as to allow communication between the second data source and the network when they are connected to
the module but not to transmit data between the first restricted interface means and the second interface means, and being arranged to transmit data from the second restricted interface means to the second interface means and from the second interface means to the second restricted interface means so as to allow communication between the second data source and first data source when they are connected to the module but not to transmit data between the second restricted interface means and the first interface means.

21. A VOIP telephone having first and second sources to a network using a single network connection, comprising:
first and second interface means respectively for passing data to and from the network and to and from the first data source, the module being arranged to transmit data from the first interface means to the second interface means and from the second interface means to the first interface means so as to allow communication between the first data source and the network when they are connected to the module; and
first and second restricted interface means both for passing data to and from the second data source,
the module being arranged to transmit data from the first restricted interface means to the first interface means and from the first interface means to the first restricted interface means so as to allow communication between the second data source and the network when they are connected to the module but not to transmit data between the first restricted interface means and the second interface means, and being arranged to transmit data from the second restricted interface means to the second interface means and from the second interface means to the second restricted interface means so as to allow communication between the second data source and first data source when they are connected to the module but not to transmit data between the second restricted interface means and the first interface means;
wherein the VOIP telephone is connected to the module as the second data source.

22. A computer as claimed in claim 20 further comprising a VOIP telephone connected to the module as the second data source.

23. A VOIP telephone as claimed in claim 21 further comprising a computer workstation as the first data source.

24. A method of using a module as claimed in claim 1, wherein the majority of data flow is between the first and second interface modules.
